(19) United States
(12) Patent Application Publication
(10) Pub. No.: US 2005/0080608 A1
(43) Pub. Date: Apr. 14, 2005

(54) Simulator for request/response systems

(76) Inventors: Joe Burns, Wilmington, DE (US); Matt Van Vleet, Hilliard, OH (US); Dustin Williams, Dublin, OH (US); Mike Miller, Dublin, OH (US)

Correspondence Address: CONNOLLY BOVE LODGE & HUTZ LLP, SUITE 800, 1990 M STREET NW, WASHINGTON, DC, 20036-3425, US

(21) Appl. No.: 10/608,021

(22) Filed: Jun. 30, 2003

(51) Int. Cl. G06F 17/50

(52) U.S. Cl. 703/22

(57) ABSTRACT

A simulator for request/response systems may be mechanized without the use of manual programming or coding. An interactive rule creation window, supported by a GUI, allows the user to create a rule for fashioning a reply to a message. The rule specifies which messages it applies to and describes the appropriate response. The rule is created in the form of metadata through the rule creation window. In one embodiment, the metadata is compiled and made accessible to a response engine. If desired, additional rules may be created in similar fashion. Any rule can be edited to alter the rule it represents. The response engine has access to the rule or rules and reacts to receipt of a message to interact with the compiled rules to either produce an appropriate response or no response as called for in the rules.

### FIELD OF INVENTION

The invention relates to improvements in testing and more particularly a simulator for simulating a request/response system.

### APPENDIX

Attached to this specification is an appendix describing components of an embodiment of the invention actually constructed and including:

| | |
|---|---|
| Class RawMessageView | 7 pages |
| Class FixedFormatMessageView | 9 pages |
| Class XMLMessageView | 9 pages |
| Interface ISetCurrentData | 1 page |
| Class TabbedMessageViewer | 11 pages |
| Class ViewerUti1 | 2 pages |
| Class DataSubConstants | 2 pages |
| Class DataSubstitutionDig | 10 pages |
| Class DataSubstitutionUti1 | 3 pages |
| Interface IDataSubstitutionDecoder | 2 pages |
| Interface IDataSubstitutionMethods | 3 pages |

### BACKGROUND OF THE INVENTION

As computer technology has advanced, one class of systems which has been created are sometimes called request/response systems. In these systems, a request is presented for processing, and the processing results in, among other things a response. One example of request/response systems are credit card processing systems wherein a request representing information with respect to a credit transaction is presented for processing and that processing results in a response. There are many other applications for request/response systems.

As computer technology has advanced, the cycle time, that is, the time taken for design, construction and testing of new systems has been decreased. It is a decided advantage to be able to perform any one of these functions, e.g., design, construction and testing, in as short a time as possible or at least in a time shorter than heretofore had been accomplished.

Many of today's complicated systems are built up from components. In order to verify that two components work correctly together, both components have to be constructed and then tested. It would be of advantage if one of the components could be simulated so that some testing could take place before construction was completed.

Thus the present invention is directed at simulating request/response systems. It is well known in the computer field that a given system can be made to simulate another system by properly programming the given system. Programming, however, is also well known as a complex and demanding skill which is a tedious task even for experienced programmers.

### BRIEF SUMMARY OF THE INVENTION

Accordingly, in one respect, the invention is directed at allowing a user, e.g., a person who may not be acquainted with programming, to mechanize or create a simulator for simulating a request/response system. Alternatively, in another aspect, the invention will allow a user (whether or not acquainted with programming skills) to mechanize a simulator for a request/response system without the tedious and demanding steps required for programming or coding.

In connection with another aspect the invention provides for testing a logic based component by running the logic based component under test along with a simulation of another component and having communication between the component under test and the simulation of the another component. The communication can be directed from the component under test to and simulation or from the simulation to the component.

In connection with one aspect the invention includes a first mechanism for supporting interactive creation of a representation of at least one rule. The rule identifies a response which should be generated upon receipt of a request having a particular format, information content or the like.

In connection with this aspect the invention further includes a response engine which is compatible with the representation produced by the first mechanism.

On completion of the at least one rule by the first mechanism, the response engine is allowed access to the representation of the rule so that, on receipt at the response engine of a request corresponding to one forming part of the rule, the response engine will generate the corresponding reply.

Accordingly, in one aspect, the invention is a method of mechanizing a simulator for simulating a selected system producing responses on receipt of requests comprising:
interactively creating a representation of at least one rule defining a response including a representation of a request and a corresponding response of the selected system;
providing a response engine compatible with the representation of the rule; and
allowing access by the response engine to the representation the of least one rule, whereby,
on receipt, at the response engine, of a request corresponding to one forming part of the rule, the response engine may generate the corresponding reply.

In connection with one aspect, the response is dynamic and parameterizable. In particular, the response might be dynamic and parameterizable in that at least one element of a response refers to a file, a cache, database or a message so that the content of the response depends in turn on the content on the file, cache, database, or message.

In respect to another aspect of the invention, the representation of the rule may comprise metadata.

In some embodiments of the invention, the metadata may be compiled logic prior to interacting with the response engine. In different aspects of the invention creating the metadata comprises interactively using raw data, fixed format data, or XML data.

Preferably, interactively creating the metadata is implemented using a graphical user interface.

Importantly, the metadata is editable. For example, the metadata may be editable by also using a graphical user interface to produce edited metadata and in this respect alter the at least one rule so as to thereafter store the edited metadata.

Furthermore, the edited metadata may be used to produce edited compiled logic. When the response engine interacts with the edited compiled logic, the response of the response engine to a request may depend on the representation of the altered rule corresponding to the edited metadata.

In connection with another aspect of the invention testing of two components, such as logic based components, is possible even though only one of the devices has been constructed. In accordance with this aspect of the invention the device which has been constructed (termed the device under test) is tested along with a simulation of the other component. In accordance with this aspect of the invention the device under test and the simulation may be in communication. during the test. This communication may flow either from the device under test to the simulation or vice versa.

### BRIEF DESCRIPTION OF THE DRAWINGS

Various aspects of the invention will now be described in the following portion of the Specification so as to enable those skilled in the art to make and use the same when taken in conjunction with the attached drawings in which:

FIG. 1 is a block diagram of a request/response system which can be simulated by the invention.

FIG. 2 is a flowchart illustrating the various stages in mechanizing the simulator of the invention and its operation.

FIG. 3 is a block diagram illustrating a the simulator in accordance with the present invention.

FIG. 4 is a block diagram of the operation of the simulator.

FIG. 5 illustrates the graphical aspect of an interactive rule creation window specific to rule creation using raw data.

FIG. 6 illustrates the graphical aspect of an interactive rule creation window specific to rule creation using fixed format data.

FIG. 7 illustrates the graphical aspect of an interactive rule creation window specific to rule creation using XML data.

FIG. 8 is an illustration of the window of FIG. 7 after the user has begun to add logical content to the rule being created.

FIG. 9 is an illustration of the window of FIG. 7 after the user has added logical content, beyond that shown in FIG. 8, to the rule being created.

FIG. 10 is an illustration of the window of FIG. 7 after the user has added logical content, beyond that shown in FIG. 9, to the rule being created.

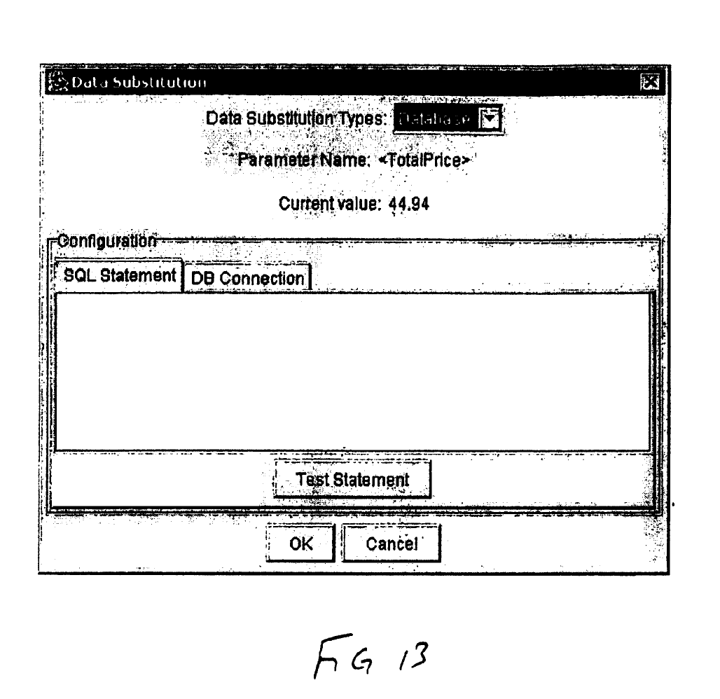

FIG. 11 is an illustration continuing the steps of rule creation, wherein the user is selecting a value for a reply which is to me mapped from the input, i.e., the request or message.

FIGS. 12-14 illustrate a window allowing using data in the reply from a file, cache or a database.

FIG. 15A represents a view of the visible portion of the GUI using input in RAW form, with a partially completed rule (focusing on the TYPE field of the request or message).

FIGS. 15B1 and 15B2 illustrate the resulting metadata.

FIG. 15c represents the compiled JAVA logic, compiled from the metadata of FIGS. 15b1 and b2.

FIG. 16A represents a view of the visible portion of the GUI using input in FIXED format, with a partially completed rule (focusing on the TYPE field of the request or message).

FIGS. 16B1 and 16B2 illustrate the resulting metadata.

FIG. 16C represents the compiled JAVA code, compiled from the metadata of FIGS. 16B1 and 16B2.

FIG. 17a represents a view of the visible portion of the GUI using input in XML form, with a partially completed rule (focusing on the TOTAL PRICE field of the request or message).

FIG. 17B1 and 17B2 illustrate the resulting metadata.

FIG. 17C represents the compiled JAVA logic, compiled from the metadata of FIGS. 17B1 and 17B2.

FIG. 18 illustrates a device under test communicating with a simulation during a test, where the communication flows from the device under test to the simulation.

FIG. 19 illustrates a device under test communicating with a simulation during a test, where the communication flows from the simulation to the device under test to the simulation.

### DETAILED DESCRIPTION OF PREFERRED EMBODIMENT

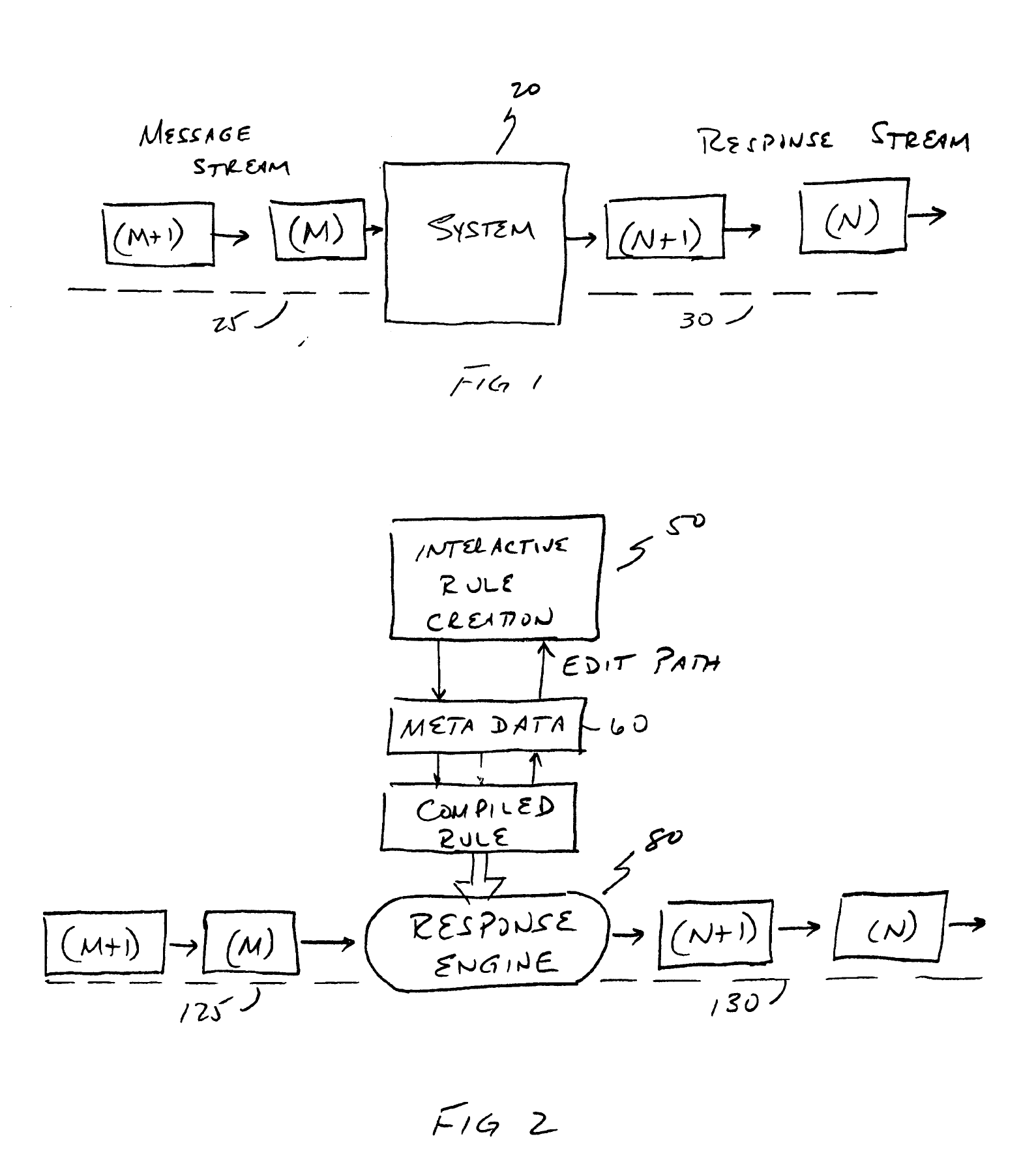

FIG. 1 illustrates the operation of the system to be simulated. In particular, the system 20 is designed to receive requests or messages and produce replies or responses. Thus, as shown in FIG. 1, the system 20 is subjected to a message stream 25. FIG. 1 shows two sequential messages being input to the system 20, message M and message M+1. FIG. 1 also shows that messages or requests generate responses or replies and FIG. 1 also shows a response stream 30. As illustrated in FIG. 1, there are responses N and N+1. It should be understood that in operation, the system 20 normally generates a single response or reply for each message or request which is received.

Typically the request/response systems will employ computer technology, although that is not essential to the invention. The simulator which is mechanized according to the invention will use computer technology. However, as will be described a user can create a simulator for the specific system without engaging in tedious programming or coding.

FIG. 1 may also be considered a block diagram illustrating the operation of the simulator of the invention. Thus the simulator replaces the system 20, but is nevertheless subjected to a message stream just as it is illustrated in FIG. 1. Likewise, the simulator, when simulating the system 20 produces a response stream also as illustrated in FIG. 1.

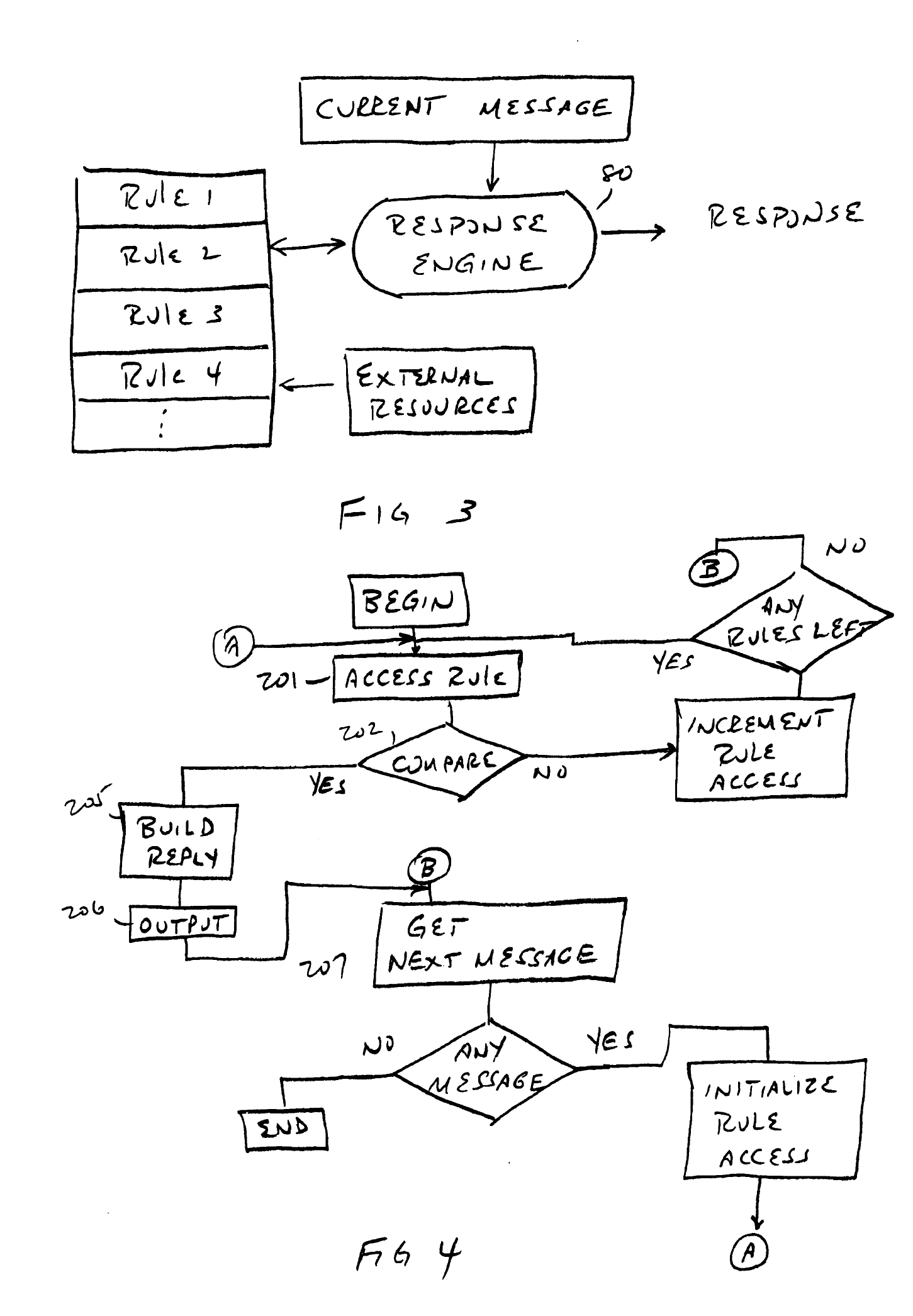

FIG. 2 is a flowchart illustrating an example of the operations executed in mechanizing a simulator for simulating a system such as the system 20 shown in FIG. 1.

As shown in FIG. 2, an interactive rule creation window 50 allows the user to create one or more rules under which the simulation of the system 20 will operate. Typically, each rule has a message or request portion and a reply or response portion. A response engine, which actually operates in response to receipt of a request or message, operates by comparing a message or request to the message or request portion of its rules. This comparison is effected sequentially, e.g., a message or request is compared first to one rule, then to the next rule and so on. When a received message or request matches the message or request portion of a rule, then the response engine generates a reply or response according to the reply or response portion of the rule.

The rules may direct the response engine to refer to file, cache or a database resources external to the rule or schedule of rules in the event a response requires data which is found in the file, cache or a database.

Thus the interactive rule creation window 50 allows the user to create one or more rules. In accordance with one embodiment of the invention, the user sits at a computer with a graphical user interface (GUI) and builds a rule by first assembling at least a portion of a message or request and then the response or reply. In an embodiment of the invention which has been constructed, the format of messages is fixed. Accordingly when a user intends to initiate rule creation using the interactive rule creation window 50, that process begins with the format of the message already present. The user can then merely modify the content of one or more of the fields, if necessary, and then specify the logical operations necessary to generate the appropriate response or reply.

The user may use a keyboard for input, however, menus may also be provided so that information for the rule need only be selected rather than being keyed.

Once the user is satisfied with a particular rule, its representation proceeds to the intermediate stage 60 at which point it may be in metadata form. Once a particular rule reaches stage 60, the user has the ability to edit the rule. To implement editing operation, the metadata representing a rule may flow back along the edit path to the interactive rule creation window 50. At the interactive rule creation window 50, the rule can be edited and then the edited rule forwarded to the intermediate stage 60.

The response engine, such as the response engine 80 can actually operate with rules in the form of the metadata at intermediate stage 60. However, the response engine operates more efficiently with the rules in compiled form. Accordingly in a preferred embodiment of the invention, the rule in metadata form at intermediate stage 60 is compiled at stage 70. Thereafter the compiled rule may be loaded into, or otherwise made accessible to, the response engine 80. Those skilled in the art will understand that the compilation process is merely preferred and if desired, the response engine 80 could operate on the rule in metadata form. It should also be apparent that while the foregoing discussion has focused on a single rule, there may be multiple rules created by the user in the interactive rule creation window 50. The complement of rules are made accessible to the response engine 80 either in the form of metadata or in compiled form.

When the response engine 80 has access to the applicable rules, it is then capable of receiving a message or request from the message stream 125, accessing the rules to determine whether or not the request matches a particular rule, and if it does, employing the response associated with rule upon which to pattern the response which is output on response stream 130.

As will be explained below, whether or not a particular request or message “matches” the message portion of a rule depends on the logical components of the rule. For example one rule may require equality between a purchase amount of the request and the rule while another rule may require an equal to or greater relation and a third rule may only require that a purchase amount is greater then zero, etc. While a rule may include a complete request, it is more typical that a rule includes only that portion of a message or request which is pertinent to the applicability of that rule. Thus is some portion of a message or request “matches” the “message” portion of a rule, then the rule is applicable to the generation of a reply to this message. Typically the content of other portions of the request or message play no part in operation of the simulator. There may, however, be instances in which the message portion of a rule has positive and negative logic, i.e., a “match” occurs in the event field 1 has one content and field 2 has some content other than another content, or where field 1 has one content and no other field has some content other than another content.

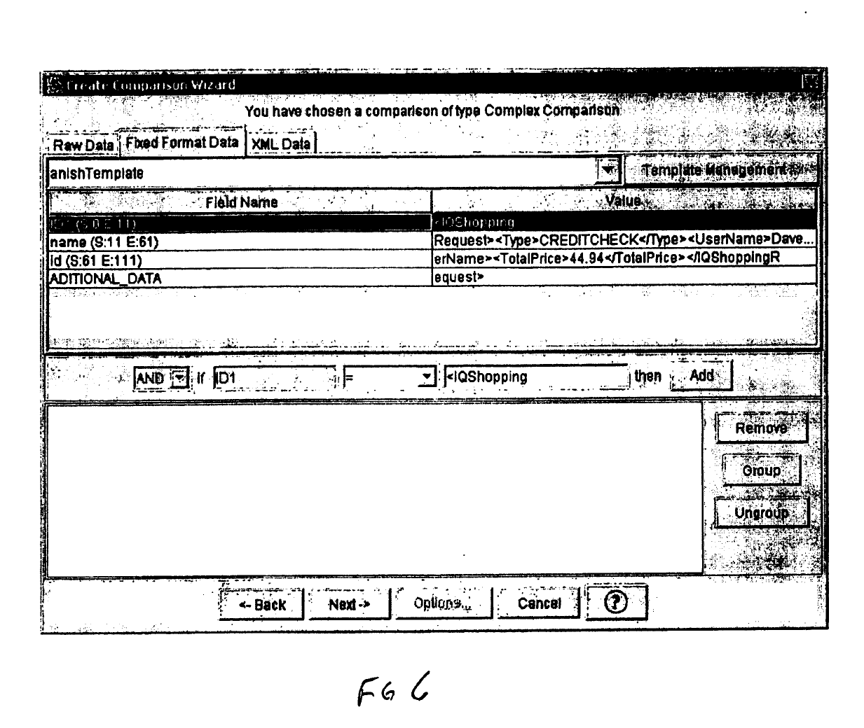

FIG. 3 is a more detailed block diagram of a typical simulator constructed in accordance with the present invention. As shown in FIG. 3, the response engine 80 has access to three sources of information. A first source is a current message 100. The current message may be made available to the response engine in a variety of ways. Particularly, the current message is made up of a number of fields each of which may include some content, e.g., non-null. Another source of information available to the response engine 80 is a sequence of rules 200. FIG. 3 illustrates that the sequence of rules 200 includes rule 1, rule 2, rule 3, and so forth. Each of the rules is a rule that has been created by the interactive rule creation window 50 and made accessible to the response engine. As it has been noted, the rule will include a representation of a request or message and a representation of a reply or response.

A third source of information is a file, cache or database. The reply or response specified in the rule may not include the entire content of the message. Rather the rule may refer to a file, cache or database for some of the content for the reply. In that event reference is made to that source in order to retrieve the information necessary for the response. FIG. 3 represents the file, cache or database as external resource 90.

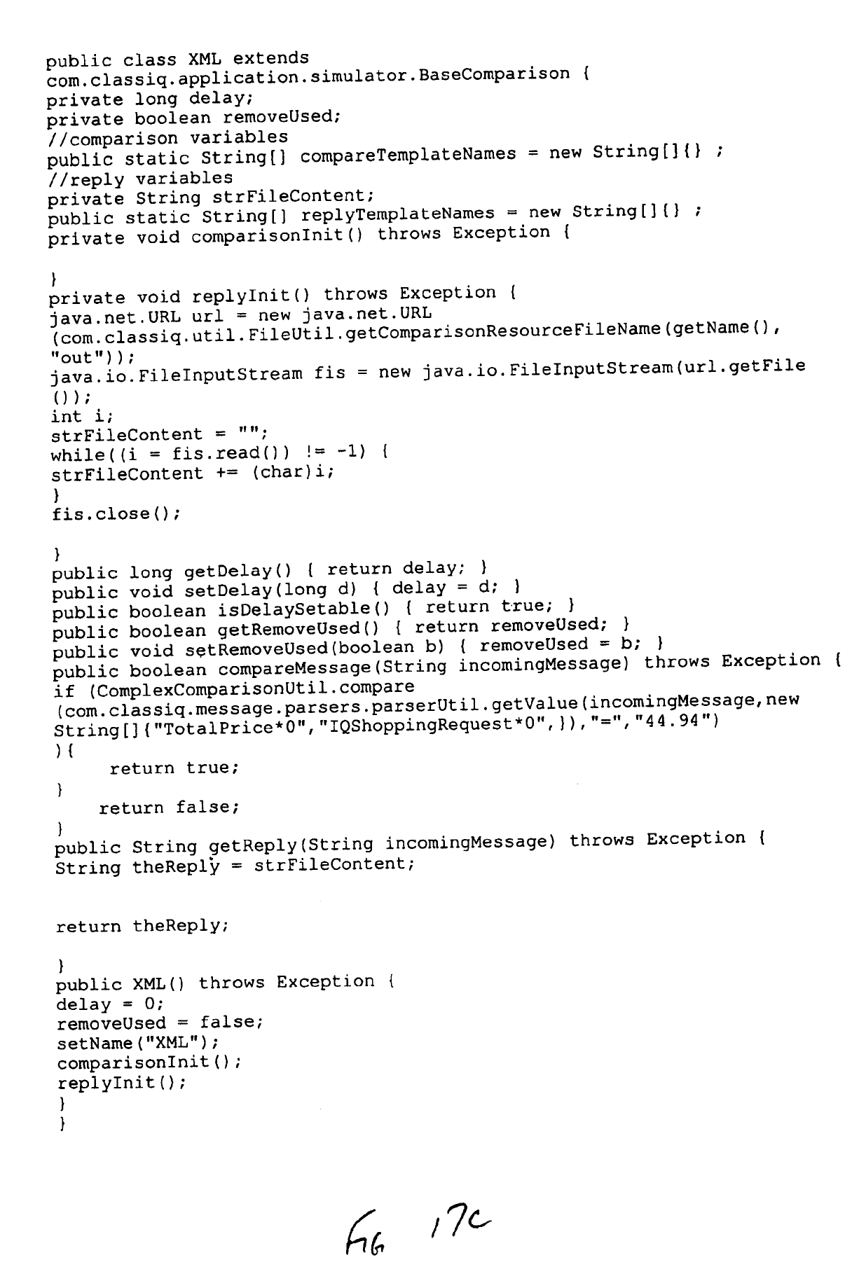

FIG. 18 illustrates an aspect of the invention which allows testing of the interaction of logic based components even though only one of the components has been constructed. Logic based components are components which are based on information technology, such as request/response systems, data storage devices, databases, communication switching systems, etc. FIG. 18 shows that a device under test 300 is connected to a simulation 400. Preferably the device under test 300 is a logic based device and is one component which is being tested so as to determine the efficacy of its interaction with another logic based component. In the case of FIG. 18 the other component has not been constructed or is not available for test purposes. Accordingly the component has been simulated, represented by the simulation 400. Preferably that simulation is effected by the principles described above. Assume for example that the device under test 300 is a switching device and the simulation 400 represents a request/response component (not available for the test) but which is intended to cooperate with the switching system 300 in normal use. Thus a test of the two devices cooperating would be useful. The path 305 may carry requests for the request response system (the subject of the simulation 400). Those of the requests which pass through the device under test 300 appear at terminal 306 and are carried to the terminal 307 of the simulation 400. The responses of the simulation 400 appear at terminal 308 and may be used as a measure of the cooperation of the device under test 300 and the request/response system even though the request/response system is not available for the test. Thus FIG. 18 represents an example where there is a flow if information from the device under test to the simulation 400.

As an alternative example the terminal 307 may connect to the write input of the external resources 90 (see FIG. 3), and terminal 304 may carry requests to the simulation 400. In this way the content of the file, cache or database (of the simulation) may be varied so as to vary the content of selected responses output at terminal 308.

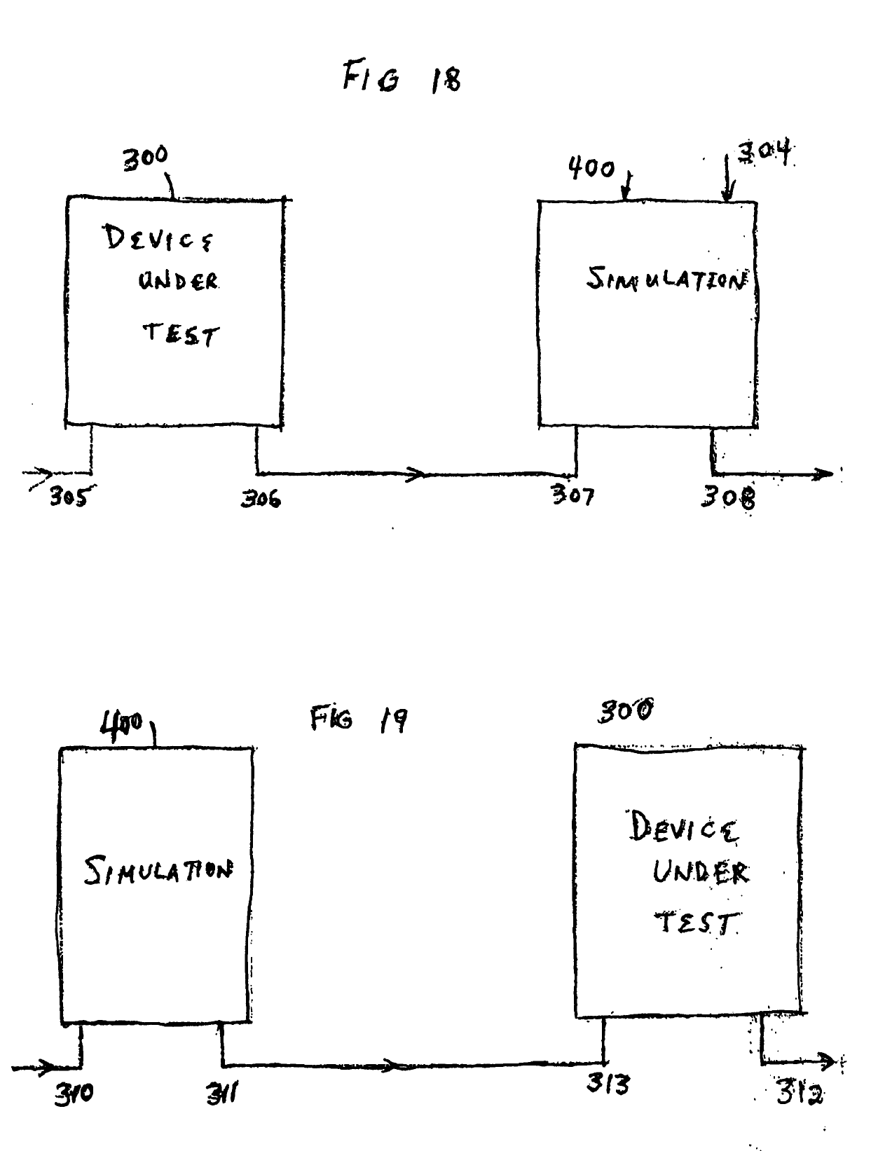

FIG. 19 represents an example similar to that of FIG. 18 except the communication is from simulation 400 to the device under test 300. In one example the terminal 310 carries a stream of messages to the simulation 400, the terminal 311 carries the resulting responses from the simulation 400 to the terminal 313 of the device under test 300. Output of the device under test 300 appears on the terminal 312.

While the preceding specification has described particular embodiments of the invention, those skilled in the art will appreciate that many changes can be made within the spirit and the scope of the invention. Accordingly, the claims should not be limited by the particular examples described herein.

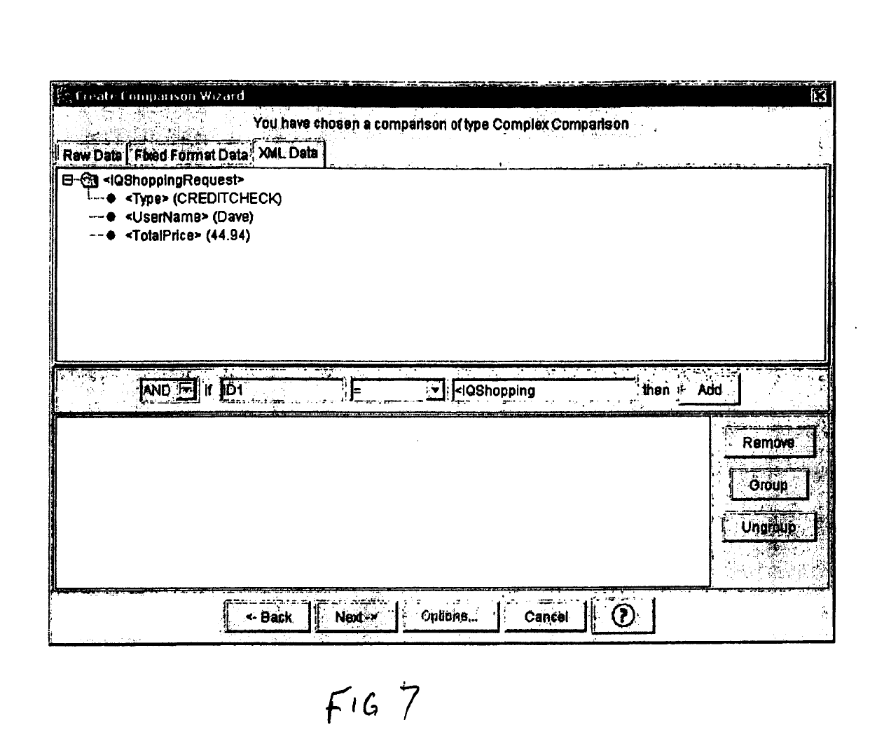

FIG. 4 is a block diagram illustrating the operation of the response engine 80. When initiated into operation, execution is initiated as indicated at begin. The flow chart of FIG. 4 assumes that the response engine 80 has access to a current message 100 and a rule or rules applicable to the simulation.

The first step, step 201-access rule, results in the response engine 80 accessing one of the rules in the set of rules 200. The next step, 202, is a decision point, determining whether the rule being accessed compares with the current message. The rule, being accessed, in addition to representing a request or message corresponding to the rule will include logical parameters so that the request or message portion of the rule can be effectively compared to the contents of the current message 100.

Assuming that the comparison is not favorable, then step 203 increments the rule access. Step 204 determines if we have rules yet to process, i.e., have we reached the end of the schedule of rules. If we have reached the end, then processing goes to step 207.

On the other hand, if there are rules yet to be accessed, then step 201 accesses the indexed rule and step 202 is again performed.

At some point, step 202 may indicate that there is a favorable comparison between the rule and the current message 100. The next step, 205 builds a reply. The manner in which the reply is built will be set forth in the rule that has been processed. As indicated building the reply may require access to a file, cache or database. In that event step 205 initiates that access in order to retrieve the specified information. Step 206, then outputs the message that has been built. Thereafter, step 207 obtains the next message. Step 208 determines if there is such a message. If not, the flowchart ends at step 209. On the other hand, if there is a next message, then step 210 is performed to initialize the rule access and return to perform step 201.

### Interactive Rule Creation Window

Optimally, in order to eliminate the necessity for tedious programming and coding the interactive rule creation window should allow a user to specify the rules for selecting a reply without requiring the user to write any code. Preferably, the interactive rule creation window is supported by Graphical User Interface, examples of which will be described below. Thus, when a rule has been created and is implemented, because the matching message has been received, the response or reply can be automatically built without further intervention. While the reply could use data or content from the request or message that is not essential and, as will be described the reply can be parameterized and dynamic so that it can refer to data files or cache and thus include in the reply or response data not found in the request or message. Moreover, because the content of the data files or cache can change as a function of time, the response is also dynamic.

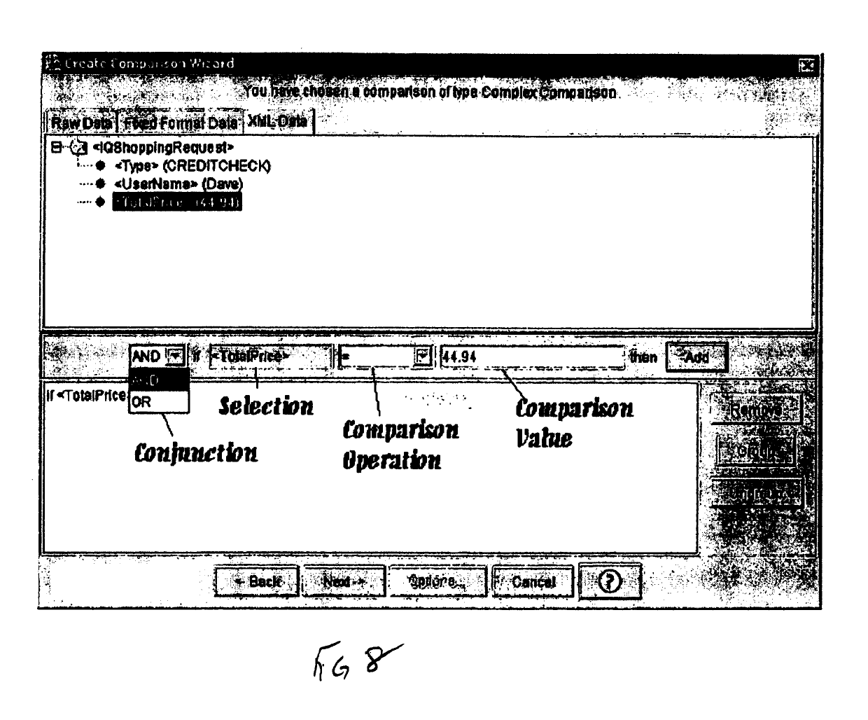

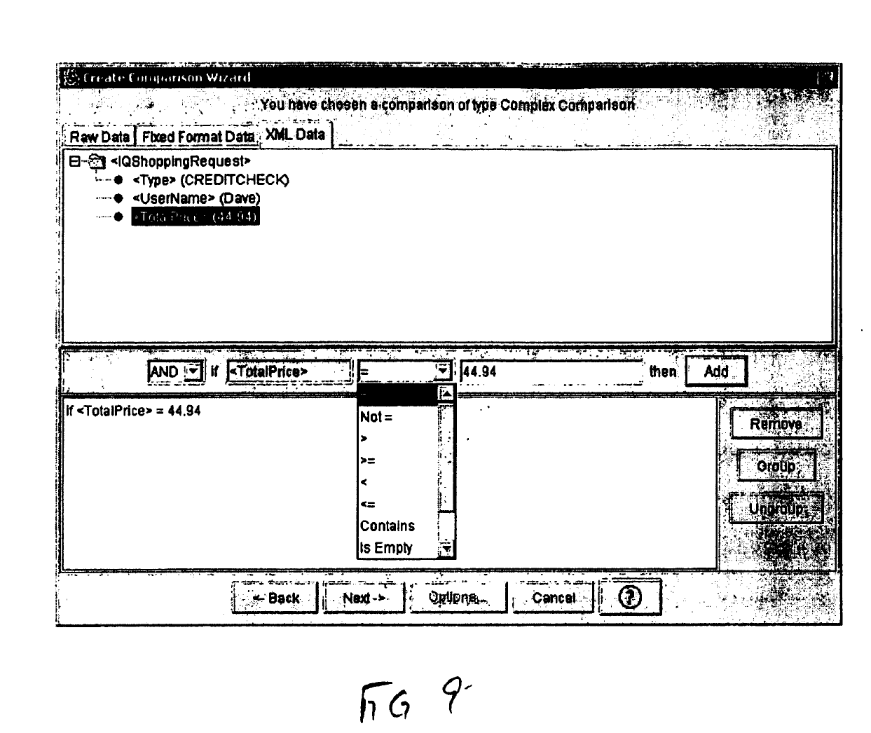

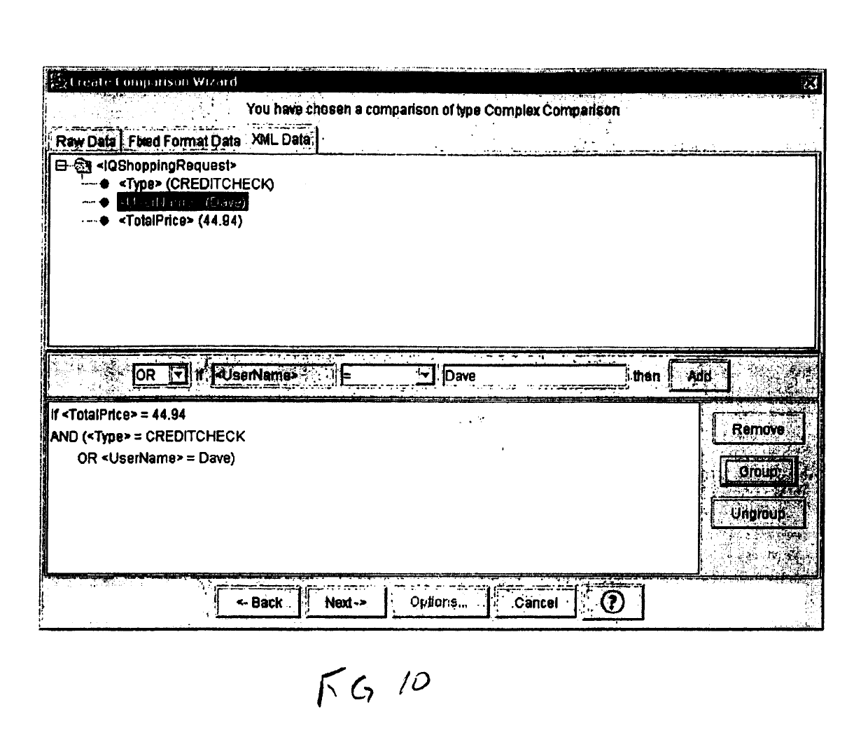

In a preferred embodiment of the invention, in order to allow users to select fields within a message, selected data should be identified for later use in the compiled comparison. Support for data selection in multiple formats is preferred. Preferred embodiments supports data in raw, fixed format or XML format. FIG. 5 is an example of a visual portion of the interface representing the interactive rule creation window dedicated to raw data; FIG. 6 represents the image portion of an interface for the interactive rule creation window supporting fixed format data; and FIG. 7 illustrates a visual portion of the interface supporting XML data. In an embodiment of the invention which has been constructed the system being simulated is a request/response system with a fixed message format. In other words the complement of fields and their order, in a request, is fixed. Thus when the user opens the interactive rule creation window, the window shows a representation of the request with predetermined data in the fields, see any of FIGS. 5-7. Of course the user may edit the predetermined data at will.

Alternatively, those skilled in the art will understand how the user of the GUI, can create the message portion of the rule such as illustrated in FIGS. 5, 6, and 7.

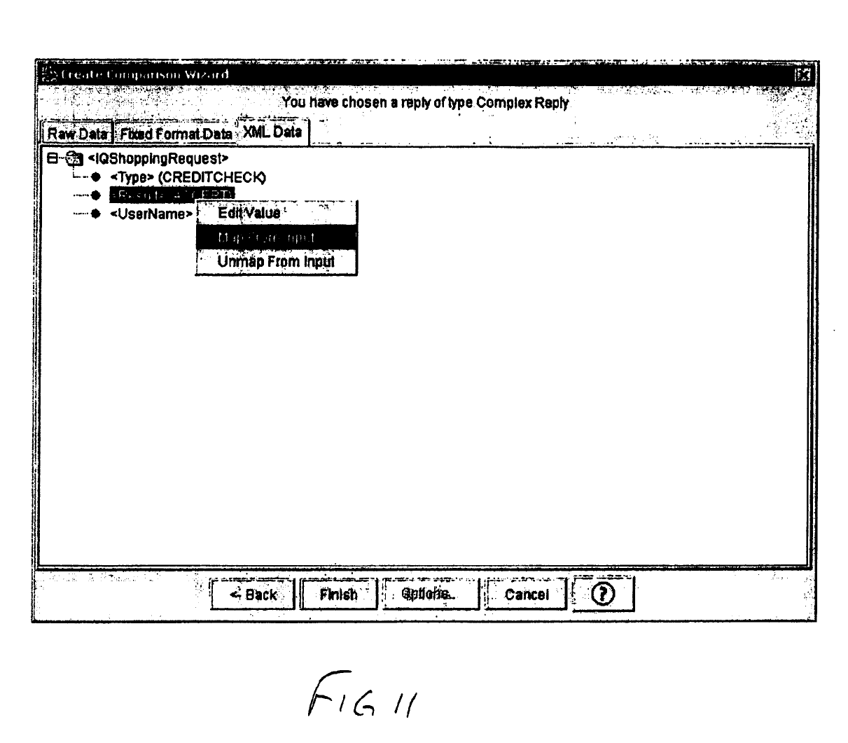

FIG. 8 illustrates the user creating a rule based on the message or request captioned in the upper portion of the window.

As is illustrated in FIG. 8, the user has selected or highlighted the total price portion of the message. A window labeled “comparison operation” allows the user to select from a number of available comparisons. A window labeled “comparison value” is a field that the user can type into or merely accept the value of the message or request.

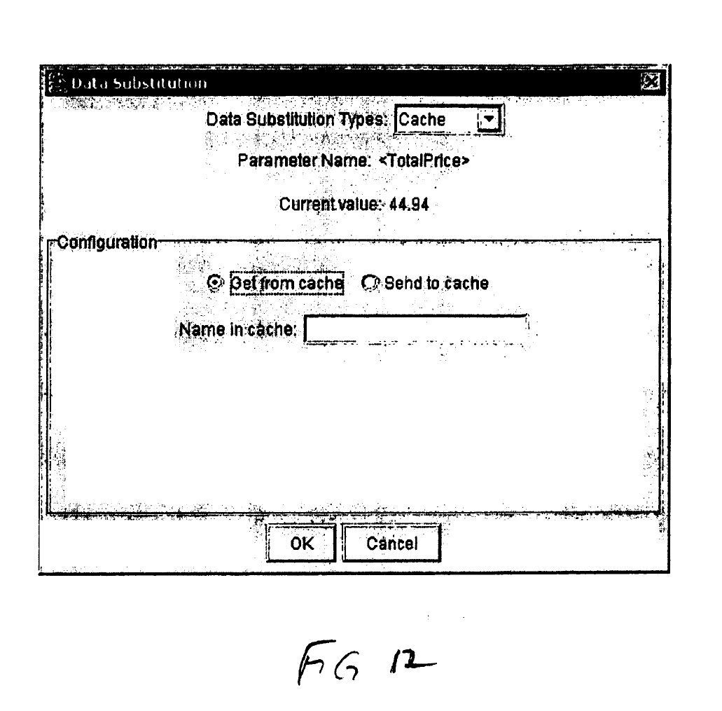

The GUI includes a set of logical operators available for rule building. That set of operators is accessible via the window identified as “Comparison Operation” in FIG. 8. FIG. 9 shows that window opened allowing selection of a logical operator from a set of eight operators. Preferably, the logical operators are extendible by being dynamically retrieved at run time. This ensures that a list of operators can be extended as needed. At generation time, the user need only put the operative name in the metadata and the generated code will call the function to evaluate the result of the operator. This provides an ability to extend the list of operations and modify their behavior without changing the core product or the generated rules.

Once the user has approved (or edited) the request or message portion of the rule, then the user will define the logical operation(s) which form part of the rule. This operation uses the lower portion of the interactive rule creation window. FIG. 8 illustrates how conjunction, selection, comparison operation and comparison function are interrelated in the rule creation process and how the GUI assists the user. Once a particular logical operation is defined another may be added by the use of the “ADD” button.

The order of operation are typical to logical expressions (can be added by highlighting the appropriate sections and selecting the “group” button.)

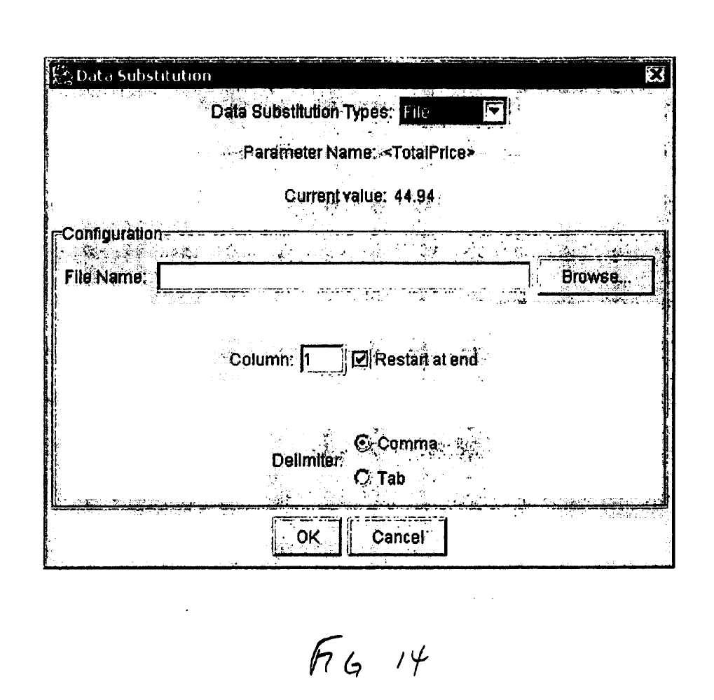

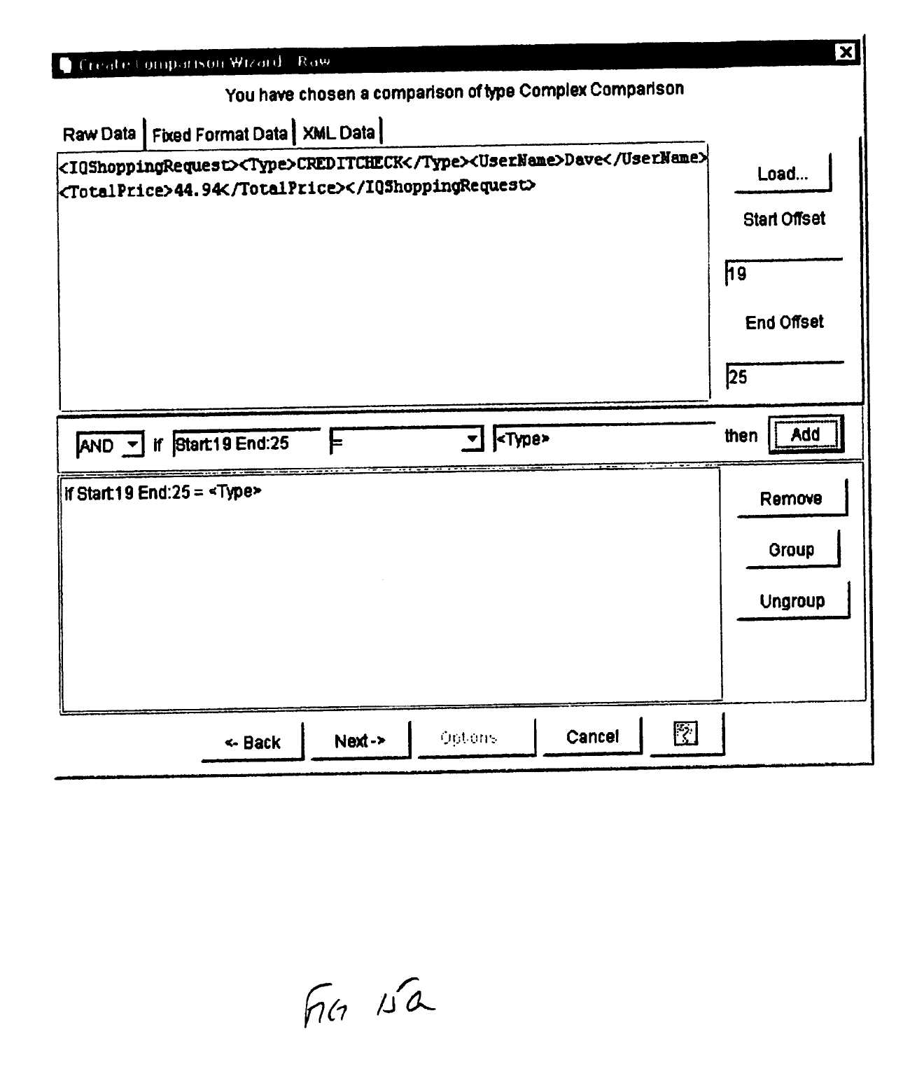

Once the message or request portion of the rule is completed the user is then faced with building the appropriate reply. So as to enable the users to complete this function without knowledge of programming or engaging in tedious coding, the Graphical User Interface is used to build the reply portion of the rule. When operating in this particular window, the users can select message to reply with. The content of the reply may repeat some or all of the data from the request. However the content of the reply is not limited to the content of the request. The reply can contain fixed data which differs from the request. This is implemented by including that fixed data in the reply in the interactive rule creation window. However the reply can be dynamic and contain data which changes with the passage of time. This is implemented by inserting into the reply, in the rule creation window, a parameter or reference, rather than fixed data or data copied from the request. The parameter or reference may refer to a file, cache or database external to the schedule of rules. The content of the file, cache or database may change with the passage of time. In this way, a response relying on such a parameter or reference will contain data from the file, cache or database and that data will change as the content of the underlying file, cache or database is changed. FIG. 11 shows the interface allowing the user to map data from the request to the reply. On the other hand FIGS. 12-14 illustrate how the user may require that a response include data from a file, cache or a database.

### Metadata Specifications

In one exemplary embodiment, once the rule, including the message or request portion as well as the proposed reply or response portion have been completed, the rule should be represented in metadata form. In this aspect of the invention, the metadata specification satisfies the following:
1. Meta Data may be defined using XML

2. A Style Sheet that displays the message using an HTML Browser may be provided.

<?xml-stylesheet type =“text/xsl”
href=“a2.metadata.xsl”?>

3. The Root element should be called “Comparison”
   and have the following attributes.
      i. baseClass—the class the generate comparison is supposed to be inherited from.
      ii. className—The name for the generated class.
   And have the following child elements
      i. Name—the logical name of the comparison for display. This may be different than the class name.
      ii. Delay—contains an integer specifying how long to wait after receiving a message to reply.
      iii. removeUsed—contains a Boolean indicating if a comparison can be reused.
      iv. comparisonType—contains all the data specific to an individual comparison Type
         1. a name attribute is required.
      v. replyType—contains all the data specific to an individual reply type.
         1. a name attribute is required.
4. The comparisonType element-rules based comparisons of many types should be supported, but in general this section should contain the following for each rule.
   Information on what data the rule applies to.
   Information on what operation the rule should perform
   For example: you may check that an accountType field includes the characters “PTFL”
5. The replyType element—many reply types should be supported. This section should include the following
   Identification of the data returned
   Detail on any dynamic data mappings from
      i. the request
      ii. a database
      iii. a file
      iv. memory

### Compilation

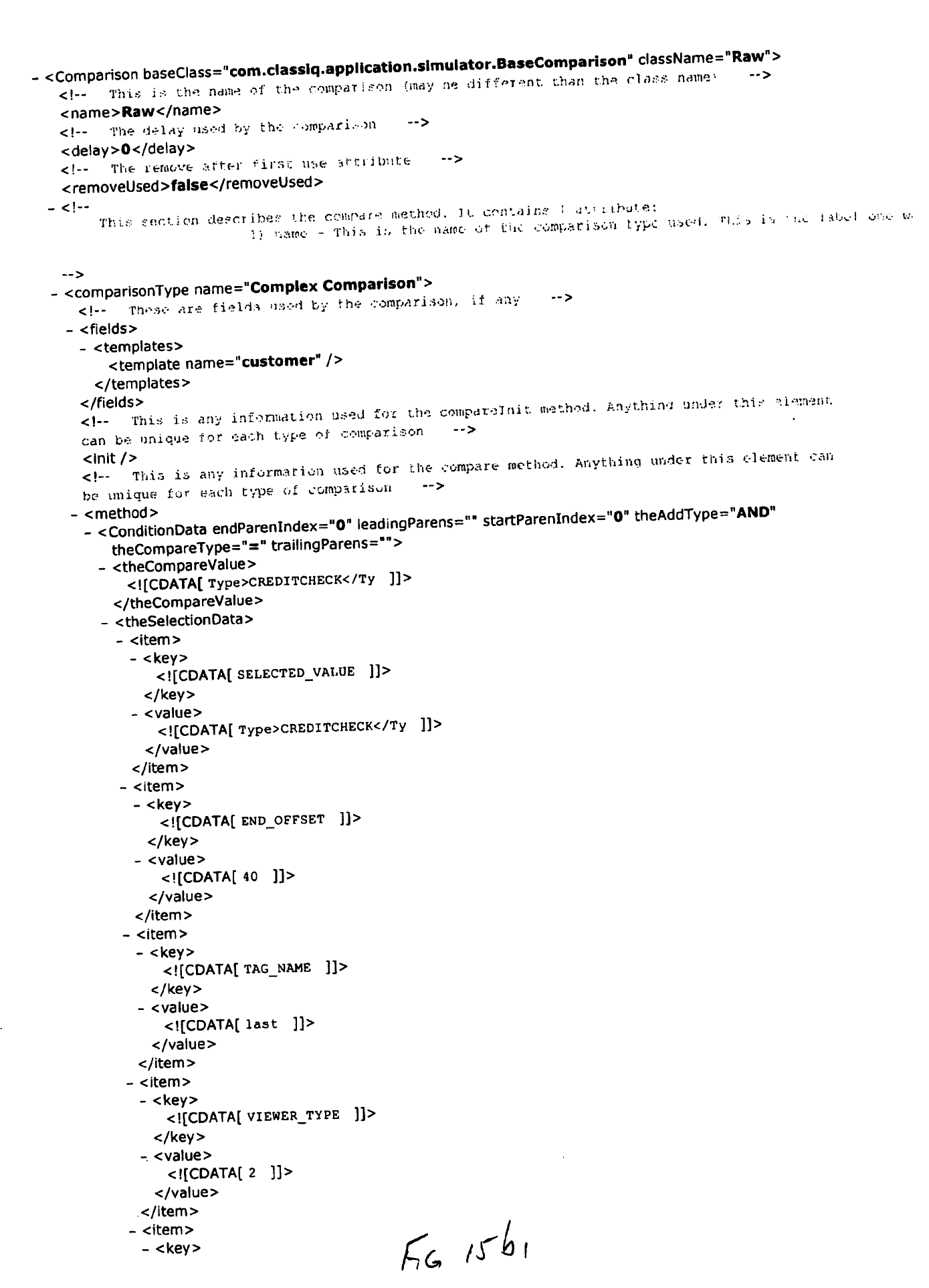

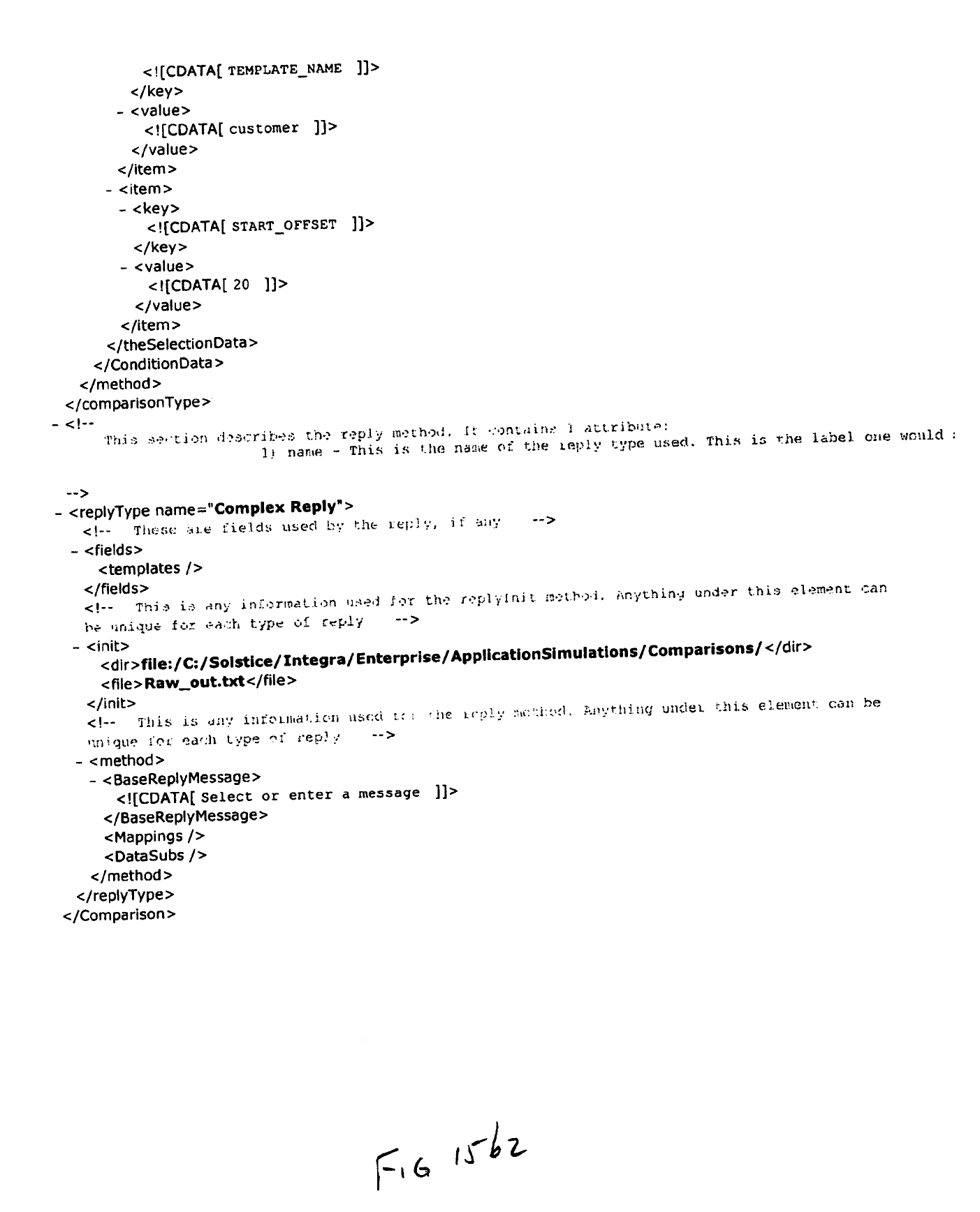

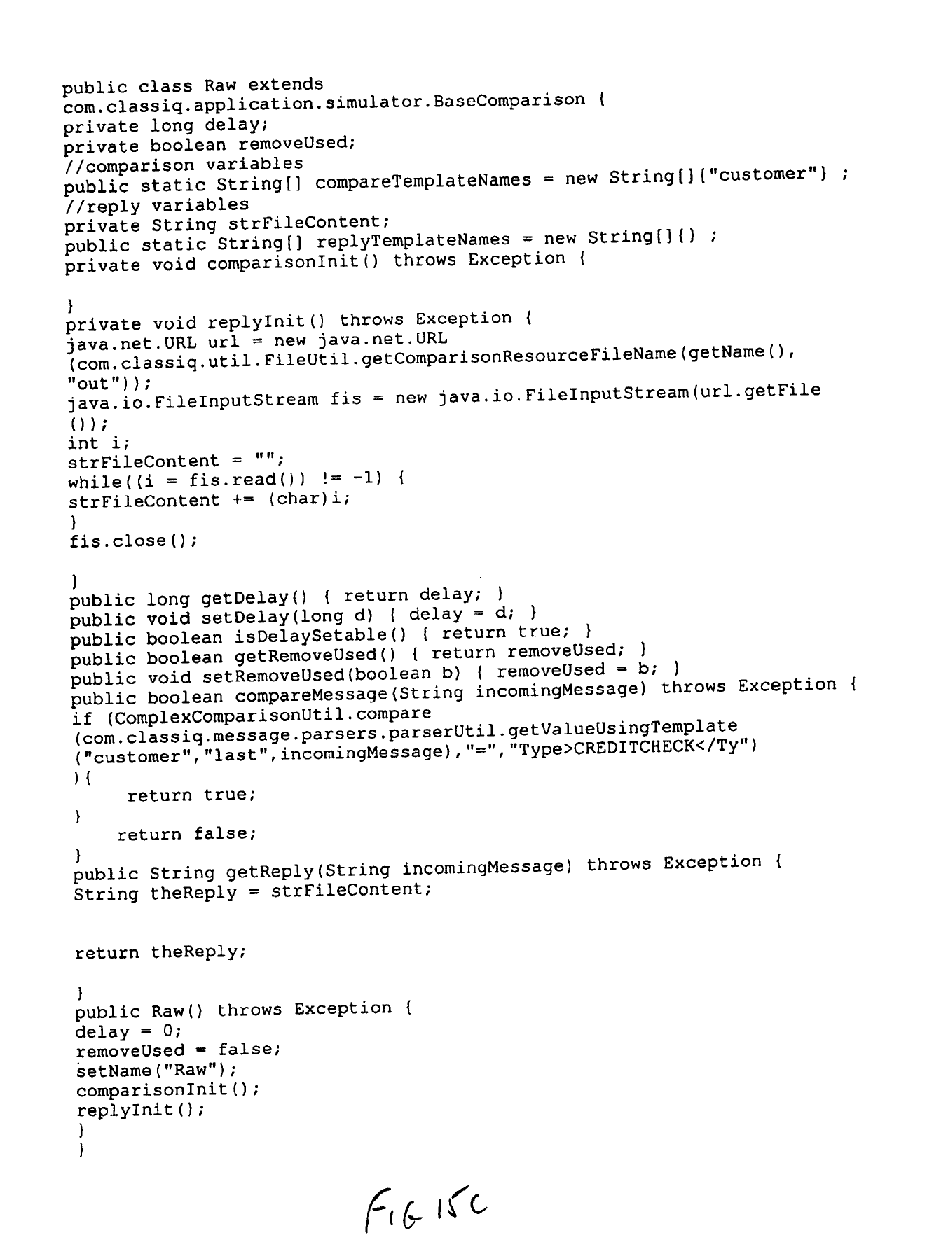

As an example of the foregoing, FIGS. 15A, 15B1, 15B2 and 15C illustrate respectively, the visible portion of GUI using the RAW form with the partially completed rule (focusing on the TYPE field of the request or message). In an embodiment of the invention actually constructed messages are fixed in terms of the fields and their order so that when rule creation is initiated, the upper window is filled with the format of the request or message. As seen in FIG. 15A, the user has selected, by highlighting, the TYPE field and used that to initiate rule creation, see the lower portion of 15A. FIGS. 15B1 and 15B2 represent the resulting metadata from this operation and FIG. 15C represents the compiled Java code corresponding to the metadata of FIGS. 15B1 and 15B2.

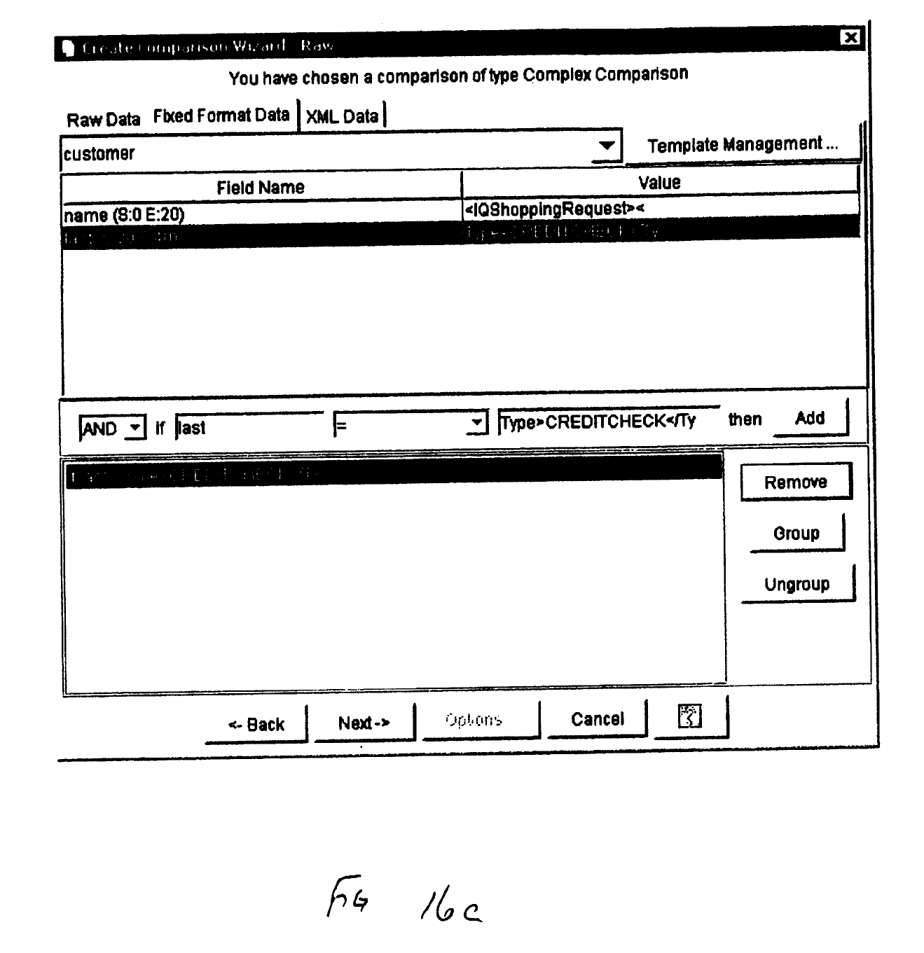

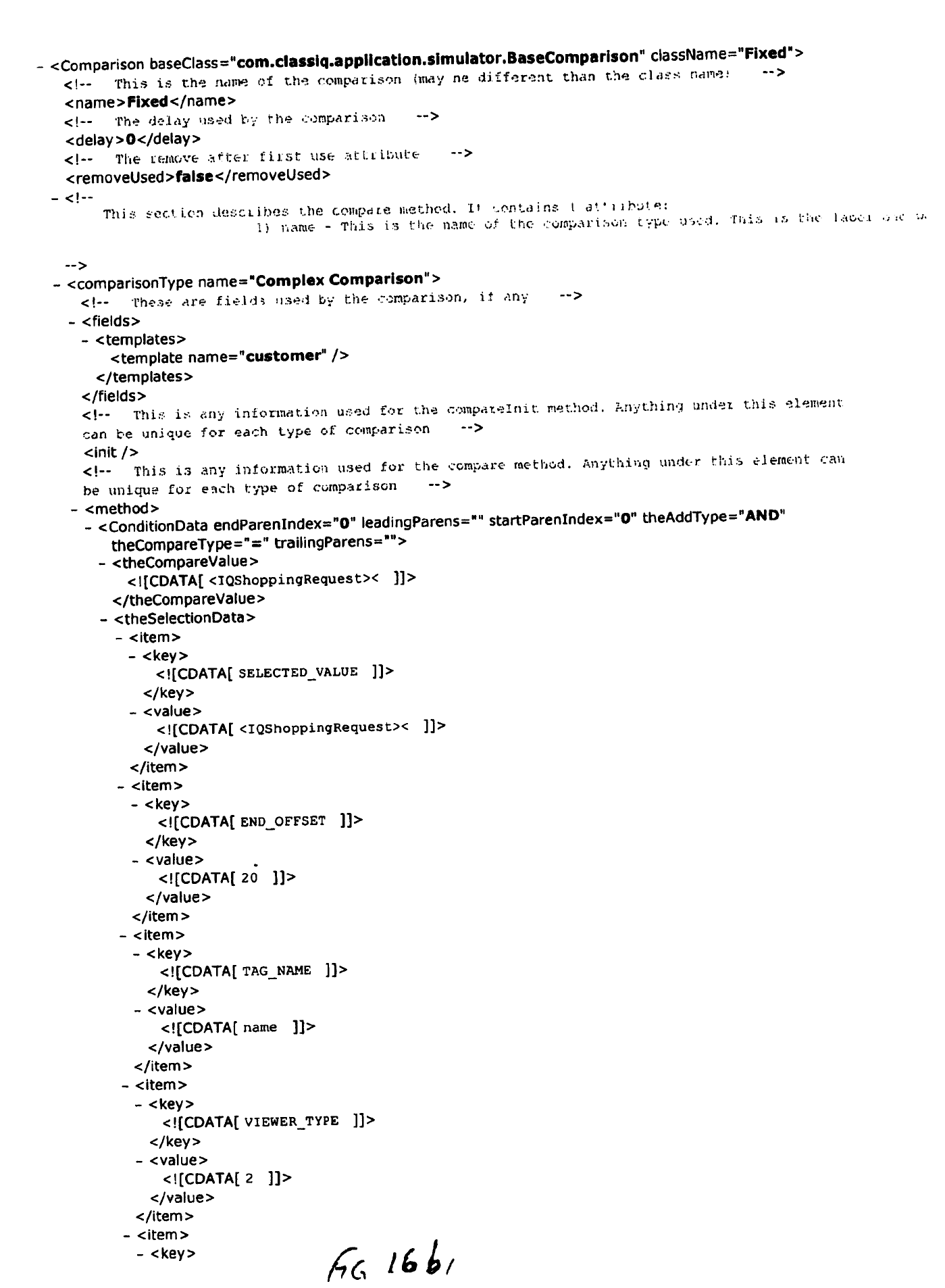

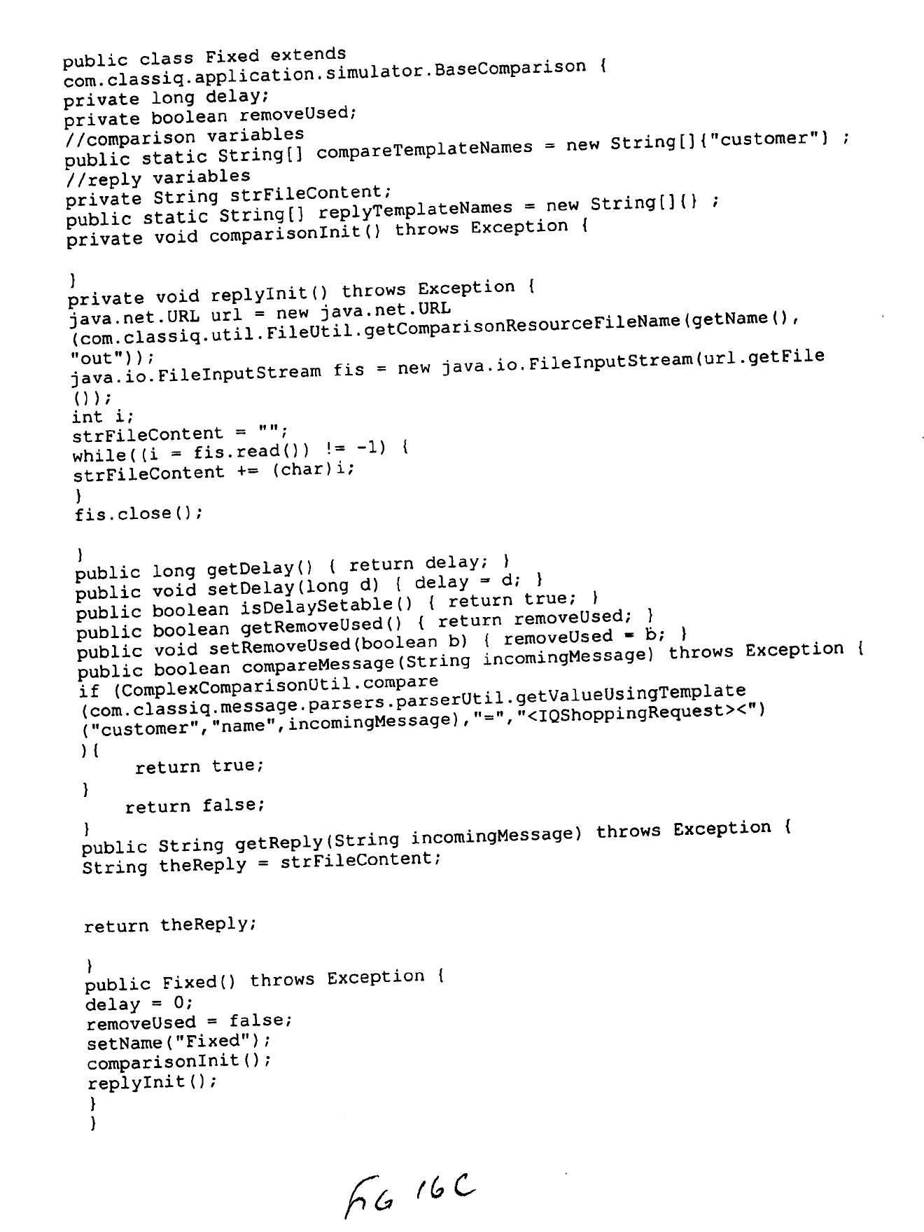

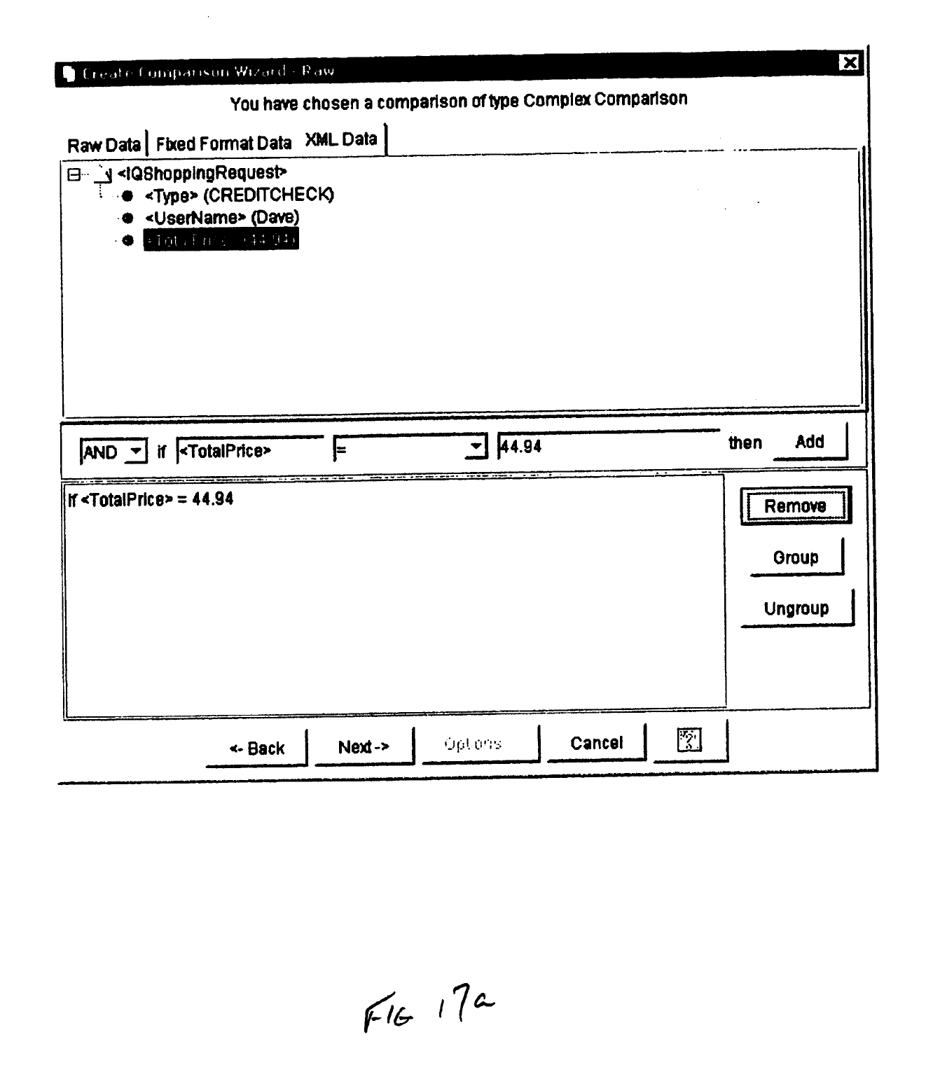

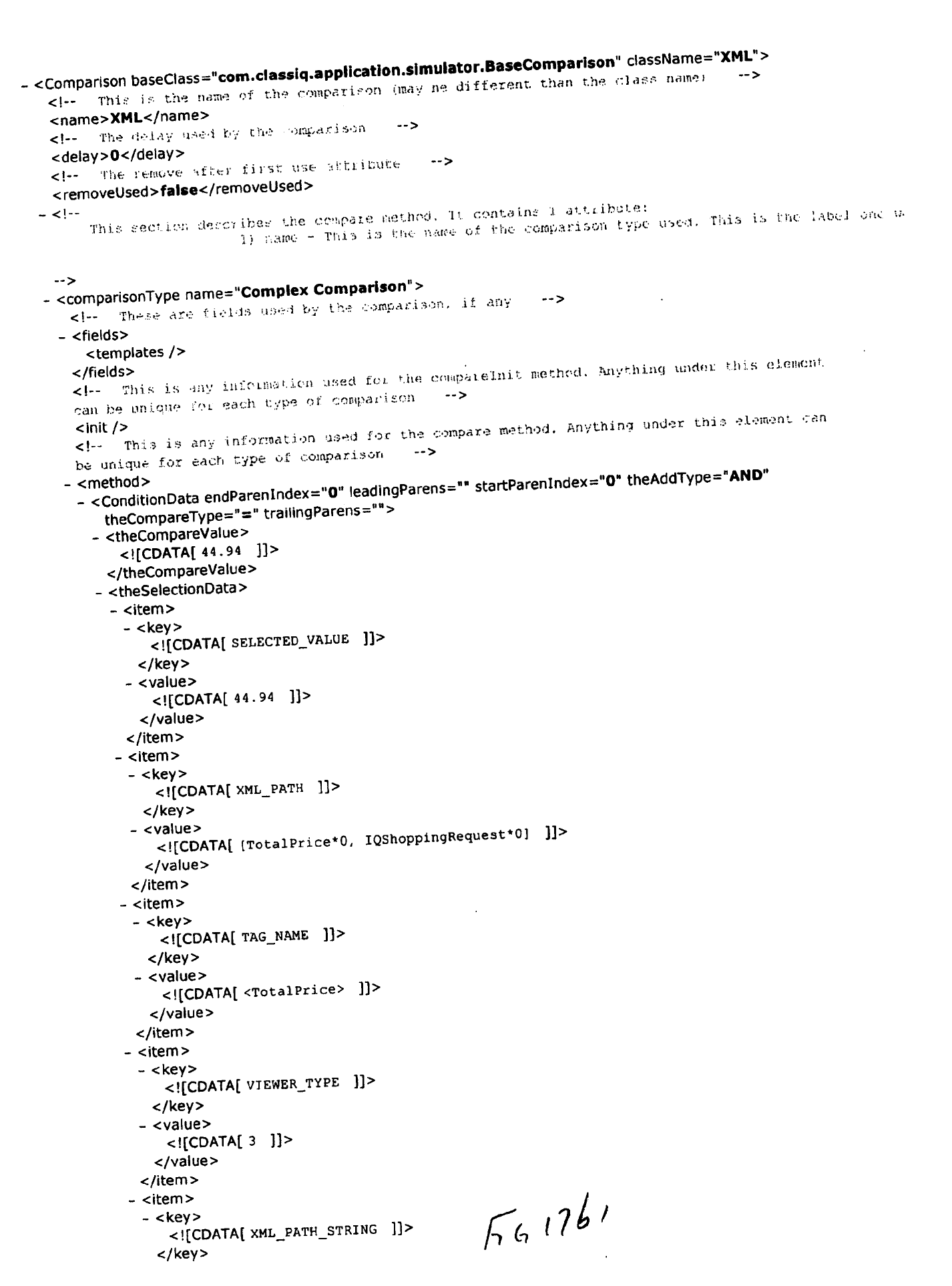

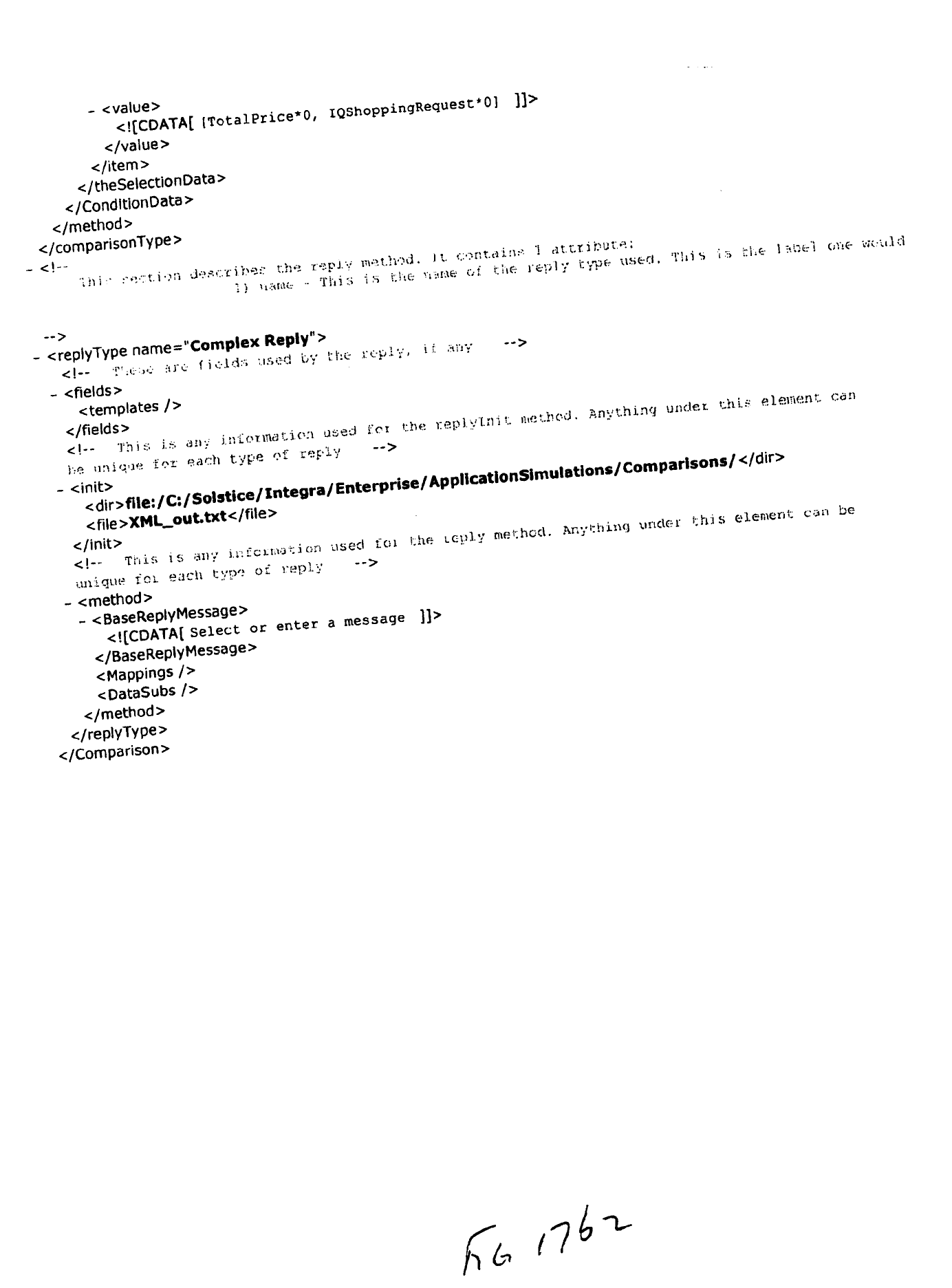

In a like fashion, FIGS. 16A, 16B1, 16B2 and 16C relates to rule creation using fixed format. Finally, FIGS. 17A, 17B1, 17B2 and 17C represent a similar operation using XML data.

As indicated in FIG. 1 when the rules have been created, in one embodiment in XML format, they are preferably compiled for execution on a response engine 80. In the embodiment of the invention which has been constructed the language which is employed for the compiled rules is Java. In the embodiment of which has been constructed, the code contains the following components:
1. Attributes for the comparison data including
   Delay—to store the delay time with the following access methods.
      i. getDelay—returns the delay
      ii. setDelay—sets the delay
      iii. isDelaySetable—controls access to the delay settings
   removeUsed—to store the removed used value with the following access methods
      i. getRemoveUsed—returns the value
      ii. setRemoveUsed—sets the value
   comparison specific—any attributes specific to a comparison type
   reply specific—any attributes specific to a reply type
2. Methods
   comparisoninit—any comparison specific initialization code.
   replyInit—any attributes specific to a comparison type
   compareMessage—performs a comparison on an incoming message and replies with true if the comparison should reply
      i. Should be Passed the incoming message
      ii. This generated code should be comparison type specific.
   getReply—if called should respond with the reply message
      i. Should be Passed the incoming message
      ii. This generated code should be specific to the reply type.

Compiled code needs access to several utility classes to help gain access to the data and perform the comparison.
ComplexComparisonUtility—to perform the comparisons.
ParserUtil—The attached interface should be supported.

### Response Engine Specification

The response engine should receive and reply to messages as a standard server simulation, but also provide support for rules which are dynamic and be capable of cooperating with any rule in accessing data from external resources.

Rule based simulations are an extension of standard stubs. A standard stub can be created through a protocol by:
1. Implementing the Application Program Interface (API) for listening for a message
2. Access the rule which will generate a reply; and
3. Implement the response API.

While the preceding specification has described particular embodiments of the invention, those skilled in the art will appreciate that many changes can be made within the spirit and the scope of the invention. Accordingly, the claims should not be limited by the particular examples described herein.
What is claimed as new and desired to be protected by Letters Patent of the United States is:

1. A method of mechanizing a simulator for simulating a selected system producing responses to requests comprising:
interactively creating a representation of at least one rule defming a response including a representation of at least a portion of a request and a corresponding response of the selected system;
providing a response engine compatible with the representation of the rule; and
allowing access by the response engine to the representation of the at least one rule, whereby
receipt, at the response engine of a request forming part of the rule will generate the corresponding reply.

2. The method of claim 1 wherein the response is dynamic.

3. The method of claim 2 wherein a parameter of the response allows access to a file.

4. The method of claim 2 wherein a parameter of the response allows access to a cache.

5. The method of claim 2 wherein a parameter of the response allows access to a database.

6. The method of claim 2 wherein a parameter of the response allows access to the message.

7. The method of claim 1 wherein the representation of the at least one rule is metadata.

8. The method of claim 7 which further includes compiling the metadata representing the at least one rule.

9. The method of claim 8 wherein creating the metadata comprises interactively using raw data.

10. The method of claim 8 wherein creating the metadata comprises interactively using fixed format data.

11. The method of claim 8 wherein creating the metadata comprises interactively using XML data.

12. The method of claim 8 where interactively creating metadata is implemented with a graphical user interface.

13. The method of claim 8 which further includes storing the metadata.

14. The method of claim 13 which further includes editing the metadata using the graphical user interface to produce edited metadata to alter the at least one rule and storing the edited metadata in the database.

15. The method of claim 14 which further includes compiling the edited metadata to produce edited compiled logic and allowing access by the response engine to the edited compiled logic whereby a selected system producing responses produced by the altered rule may be simulated.

16. The method of claim 1 which includes storing more than one rule.

17. A simulator for simulating a selected system producing responses to requests comprising:
means supporting interactive creation of a representation of at least one rule defining a response including a representation of at least a portion of a request and a corresponding response of the selected system;
a response engine compatible with the representation of the rule; and
an access path from the response engine to the representation of the at least one rule, whereby
receipt, at the response engine of a request forming part of the rule will generate the corresponding reply.

18. The simulator of claim 17 which further includes storage for data accessed by at least one said rule whereby the simulated response is dynamic.

19. The simulator claim 18 wherein a parameter of the response allows access to a file for access to the data.

20. The simulator of claim 18 wherein a parameter of the response allows access to a cache for access to the data.

21. The simulator claim 18 wherein a parameter of the response allows access to a database for access to the data.

22. The simulator claim 18 wherein a parameter of the response allows access to a message for access to the data.

23. The simulator of claim 17 wherein the representation of the at least one rule is metadata.

24. The simulator claim 17 which further includes means for compiling the metadata representing the at least one rule into compiled logic.

25. The simulator of claim 17 which includes a graphical user interface for interactively creating the at least one rule

26. The simulator of claim 25 which further includes means for editing the metadata using the graphical user interface to produce edited metadata to alter the at least one rule.

27. A method of testing logic based components comprising:
mechanizing a simulation of one of the components,
connecting the simulation to the other component; and
directing a flow of information to the connected simulation and component for testing purposes.

28. The method of claim 27 wherein the flow of information is directed to the component and a flow of information from the component is directed to the simulation.

29. The method of claim 27 wherein the flow of information is directed to the simulation and a flow of information from the simulation is directed to the component.

30. The method of claim 27 wherein mechanizing a simulation of one of the components comprises:
interactively creating a representation of at least one rule defining a response including a representation of at least a portion of a request and a corresponding response of the selected system;
providing a response engine compatible with the representation of the rule; and
allowing access by the response engine to the representation of the at least one rule, whereby
receipt, at the response engine of a request forming part of the rule will generate the corresponding reply.

31. The method of claim 30 wherein the request represents an instance in a flow of information from the component.

32. The method of claim 30 wherein the reply represents an instance in a flow if information to the component.
